(19) United States
(12) Patent Application Publication
(10) Pub. No.: US 2009/0150432 A1
(43) Pub. Date: Jun. 11, 2009

(54) RECRUITER REFERRAL WIDGET

(75) Inventors: Sean Kane, San Jose, CA (US); Brian Souza, San Diego, CA (US); Matthew Gahr, Carlsbad, CA (US)

Correspondence Address: SCHWEGMAN, LUNDBERG & WOESSNER, P.A., P.O. BOX 2938, MINNEAPOLIS, MN, 55402, US

(73) Assignee: GETLISTED, INC, SAN DIEGO, CA (US)

(21) Appl. No.: 11/951,835

(22) Filed: Dec. 6, 2007

(51) Int. Cl. G06F 17/00

(52) U.S. Cl. 707/104.1

(57) ABSTRACT

A method and system to manage web content is provided to generate an abstraction layer between a web application and content, based on a formal definition of content referred to as a content contract. An example recruiter referral widget comprises an event detector, a referral code module, and an upload module. The event detector may be configured to detect, at a third party system, a referral event associated with a resume document. The referral code module may be configured to obtain a referral code. The referral code may be generated at an employment marketplace organization to uniquely associate the resume document with the third party. The upload module may be configured to upload the resume document and the associated referral code to the employment marketplace organization.

### TECHNICAL FIELD

This application relates to a method and system to facilitate referrals in the context of a network-based employment marketplace.

### BACKGROUND

In employment marketplace, the matching of qualified candidates with prospective employees can be a challenging task. A recruiter may collect resumes from prospective employees (candidates) and then attempt to place the candidates with employers that have job openings. A recruiter or an employment agency may have limited resources to process all of the incoming resumes, which may result in a failure to place a qualified candidate.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example embodiment may be implemented;

FIG. 2 is an overview diagram of a referral and member registration process, in accordance with one example embodiment;

FIG. 3 a block diagram of a recruiter referral widget, in accordance with an example embodiment;

FIG. 4 is a flow chart of a method to refer a candidate from a third party system to a network-based employment marketplace organization, in accordance with an example embodiment;

FIG. 5 is an example architecture illustrating the referral process, in accordance with an example embodiment;

FIG. 6 is a flow chart of a method to process a referral, in accordance with an example embodiment;

FIG. 7 is a flow chart of a method to generate and process a referral utilizing a recruiter referral widget in conjunction with a referral processing system, in accordance with an example embodiment; and

FIG. 8 is a diagrammatic representation of an example machine in the form of a computer system within which a set of instructions, for causing the machine to perform any one or more of the methodologies discussed herein, may be executed.

### DETAILED DESCRIPTION

In the field of employment marketplace, various recruiting agencies collect resumes from prospective candidates and attempt to match these prospective candidates with any job openings available to that recruiting agency. At times, a recruiting agency may receive a resume that does not match any of the available job postings. In another scenario, a recruiting agency may be capable of processing only a certain amount of resumes, placing any overflow resumes into an overflow category. These resumes, that are either determined as unmatchable by the recruiting agency or that are considered as overflow, may be discarded by the recruiting agency with or without a notification to the associated candidate. While these discarded resumes may very well be a good match for jobs that are available via a different recruiting agency, it is not always easy to identify an alternative recruiting agency that would use the discarded resume, and it is not necessarily convenient or profitable to pass these resumes along.

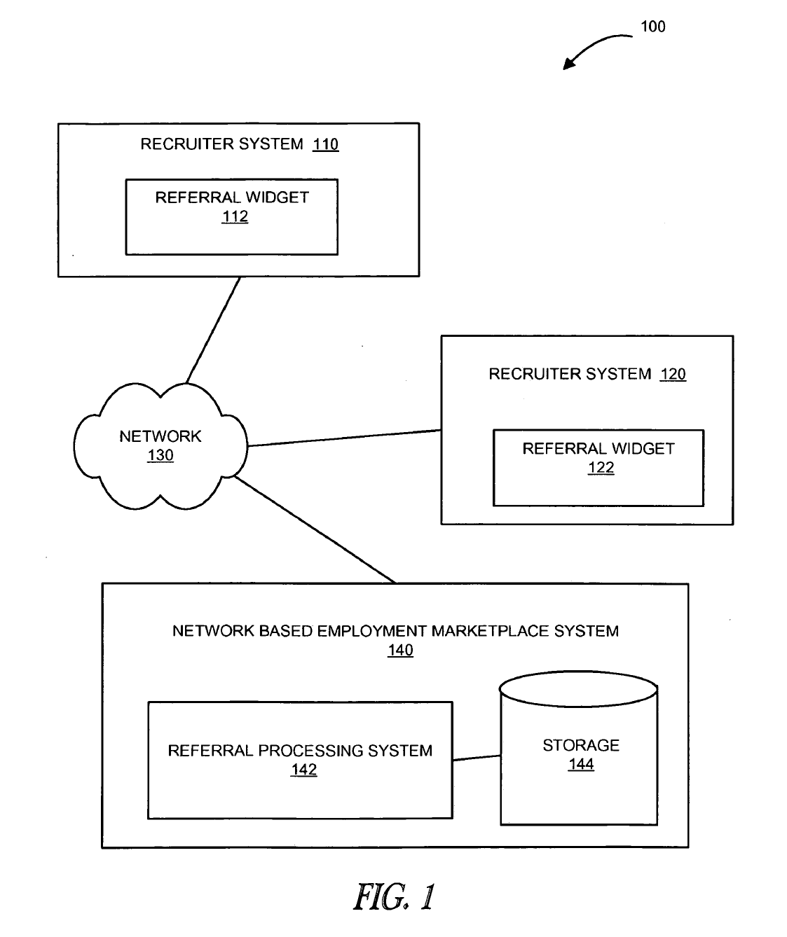

A method and system is described to encourage various third party agencies to pass along any overflow or non-matching or otherwise unusable resumes to a network-based employment marketplace. In one example embodiment, a lightweight web-deployable desktop application is provided to simplify the process of referring recruiters' and employers' candidates to an employment marketplace organization. Such lightweight web-deployable desktop application, that may be referred to as a recruiter referral widget, may monitor a predetermined repository folder for any new resume documents and, upon detecting of a new resume document in the repository folder, package the resume document and forward it automatically to the employment marketplace organization. In a further embodiment, a system to simplify a referral process may be implemented utilizing an on-demand model, such as, for example, using software as a service (SaaS) approach. An example employment marketplace organization may be a network-based system that facilitates the process of matching available job listings with profiles of qualified candidates. An example c recruiter referral widget may be implemented in the context of a network environment 100 illustrated in FIG. 1.

As shown in FIG. 1, the network environment 100 may include recruiter systems 110 and 120 and a network-based employment marketplace system 140. The network-based employment marketplace system 140 may be associated with a network-based employment marketplace organization, such as GetListed™. GetListed is a trademark of Getlisted, Inc. of Sunnyvale, Calif.

The recruiter systems 110 and 120 may be provided with respective recruiter referral widgets 112 and 122 and may have access to the network-based employment marketplace system 140 via a communications network 130. The communications network 130 may be a public network (e.g., the Internet, a wireless network, etc.) or a private network (e.g., a local area network (LAN), a wide area network (WAN), Intranet, etc.).

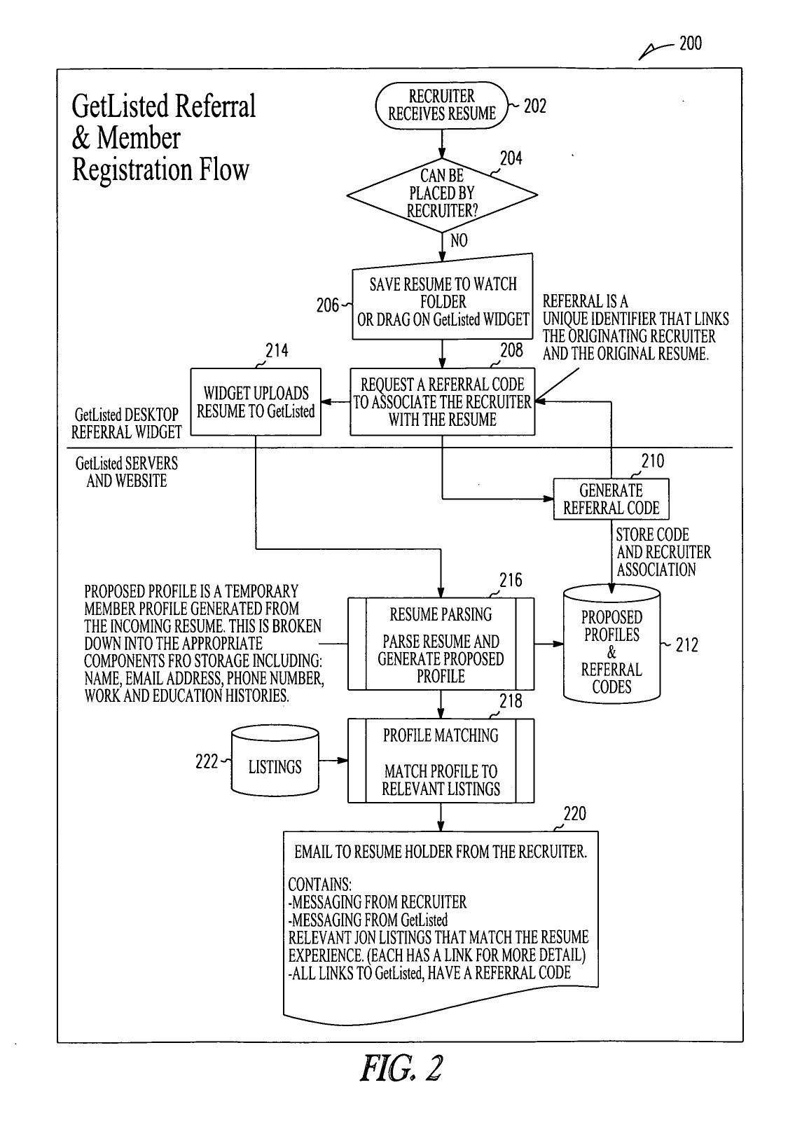

The recruiter referral widget 112 provided with the recruiter system 110 may be configured to automatically effectuate referrals of employment candidates to the network-based employment marketplace 140. The services provided by the network-based employment marketplace 140 may include matching profiles of qualified candidates with available job listings. An overview diagram of a referral and member registration process, as provided in the context of GetListed marketplace, is illustrated in FIG. 2.

As shown in FIG. 2, some operations that are part of the referral process may be performed at a client system that hosts a recruiter referral widget (here, GetListed desktop referral widget). Example client system that hosts a recruiter referral widget is a computer system associated with an employment agency. An employment agency may receive candidates' resumes (block 202), review the received resumes, and determine whether the candidates' qualifications indicated in the respective resumes may be matched with any positions that the employment agency is attempting to fill (decision block 204). The receipt and review of the resumes at the employment agency, which may be automated or manual, may result in identifying certain resumes that may be considered as unusable by the employment agency. Some reasons for identifying a particular resume as unusable may include, for example, lack of any matching job listings, as well as lack of resources at the employment agency to process all of the incoming resumes.

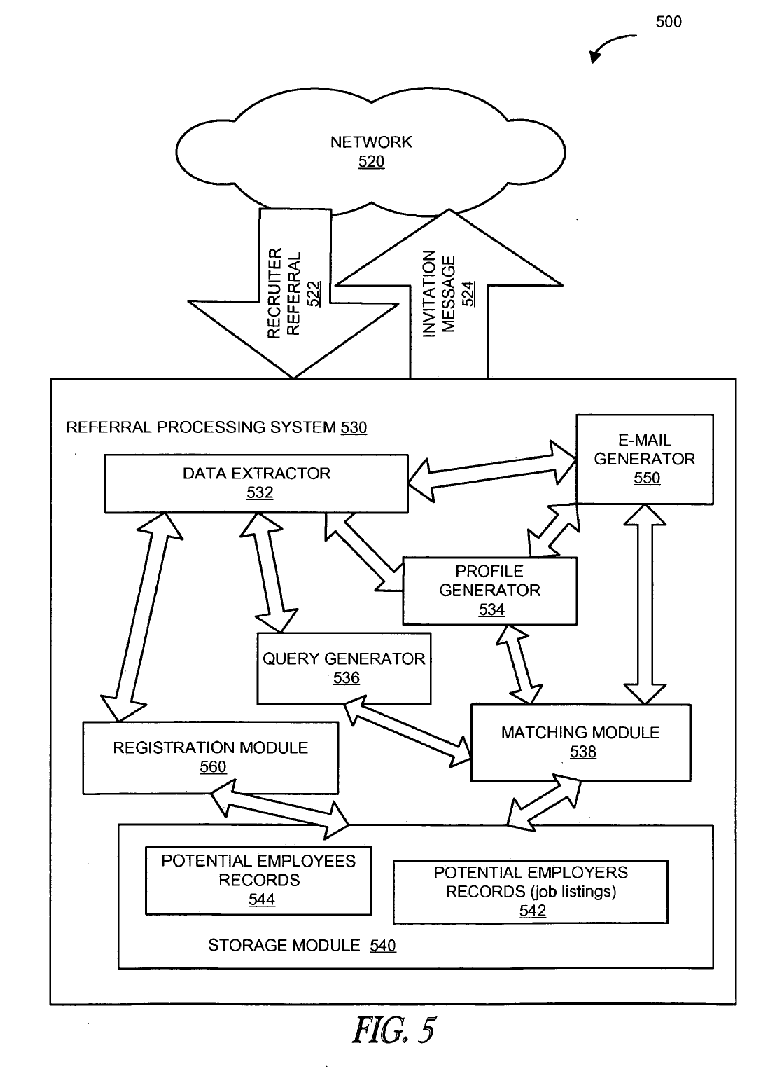

If it is determined, at the decision block 204, that a particular resume cannot be used by the employment agency, the agency may designate such resume for referral to the employment marketplace organization. As mentioned above, in order to simplify the referral process, a computer system associated with the employment agency may host a recruiter referral widget that may be configured to detect a referral event and process the referral automatically, without requiring additional steps to be performed by the employment agency. As shown in FIG. 5, this functionality is provided with the GetListed desktop referral widget.

A referral event that can be detected by the GetListed desktop referral widget, in one example embodiment, may be associated with a resume document being saved into a particular folder or being dragged, utilizing a graphic user interface (GUI) functionality, onto a visual control associated with the GetListed desktop referral widget (block 206). Next, the GetListed desktop referral widget contacts GetListed server and requests a referral code (block 208). GetListed server generates a referral code that is intended to link the originating recruiter and the resume document (block 210). It will be noted that while a referral code may be implemented as a code, the referral code may be any type of a token that can be used to provide an association between the originating recruiter and the resume document. The generated referral code is stored at the GetListed server in proposed profiles and referral codes repository 212. It will be noted that the repository 212 may be implemented in a variety of ways and may comprise one or more storage devices. The proposed profiles may be stored on the same devise as the referral codes in some embodiments, while in other embodiments the proposed profiles may be stored at a location that is different from the location where the referral codes are stored. Upon obtaining the referral code from GetListed server, GetListed desktop referral widget uploads the resume document together with the referral code to the GetListed server (block 214).

At the server side, the received resume document is parsed to obtain candidate's data for generating a proposed profile (block 216). Proposed profile, as used in one example embodiment, is a temporary profile generated for a potential member of GetListed marketplace. A proposed profile may include candidate's information such as name, e-mail address, telephone number, as well as past employment and education details. The proposed profile data is used to identify one or more matching job listings (block 218) to be provided to the candidate together with an invitation to join GetListed marketplace (block 220). Job listings may be stored at the GetListed servers in the listings repository 222. In one example embodiment, an invitation to join GetListed marketplace may include a message from the referring recruiter. In a further embodiment, a message from the referring recruiter may be sent automatically from the recruiter's client system, utilizing GetListed desktop referral widget.

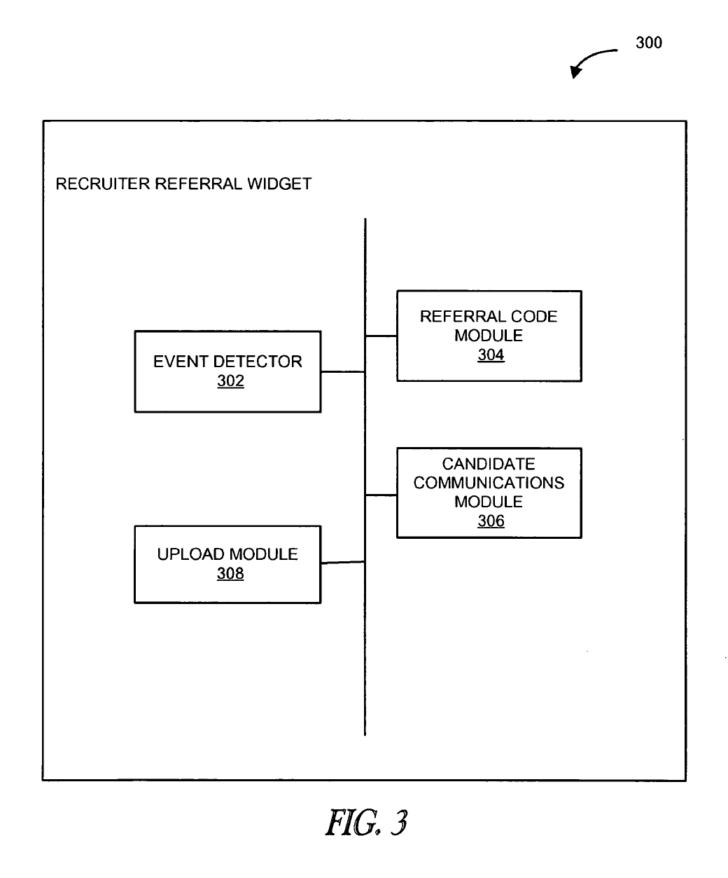

It will be noted that, while an example referral system is being described in the context of a recruiter or an employment agency, a recruiter referral widget, in one example embodiment, may be utilized advantageously to obtain leads or resumes from various organizations other than employment agencies, such as, for example, employers or employers' human resources department, alumni organizations, etc. An example recruiter referral widget may be described with reference to FIG. 3.

As shown in FIG. 3, an example recruiter referral widget 300 includes an event detector 302, a referral code module 304, a candidate communications module 306, and an upload module 308. The event detector 302 may be configured to detect, at a third party system, a referral event associated with a resume document. A referral event, as mentioned above, may include a resume document being deposited into a predetermined file folder. It may be thus sufficient for a third party user to merely drop an unusable resume into a designated folder in order for a referral to the employment marketplace organization to take place. A third party user, e.g., a user associated with a third party employment agency, may be motivated to employ the recruiter referral widget 300, e.g., because of a referral fee that may be based on a placement of a referred candidate.

In one example embodiment, the recruiter referral widget 300 may be configured to process multiple resumes simultaneously. For example, a user may be permitted to select several resume documents in a file folder and drag them onto the visual control associated with the recruiter referral widget 300 or the watch folder being monitored by the recruiter referral widget 300. In some embodiments, the recruiter referral widget 300 may be configured to accept entire file folder trees and parse them to identify newly added resumes. Multiple documents may thus be processed and referred to the employment marketplace organization in one step from the recruiter's perspective.

In order to associate any referrals that originate from a particular third party organization with that third party organization, the recruiter referral widget 300 may utilize a so-called referral code. The referral code module 304 may be configured to obtain such referral code. The referral code may be generated at the network based employment marketplace system 140 of FIG. 1 to uniquely associate the resume document with the third party. In one example embodiment, the referral code may be designed to also uniquely associate the resume referral with a specific individual working within the third party employment agency. The upload module 308 may be configured to upload the resume document and the associated referral code to the network based employment marketplace system 140.

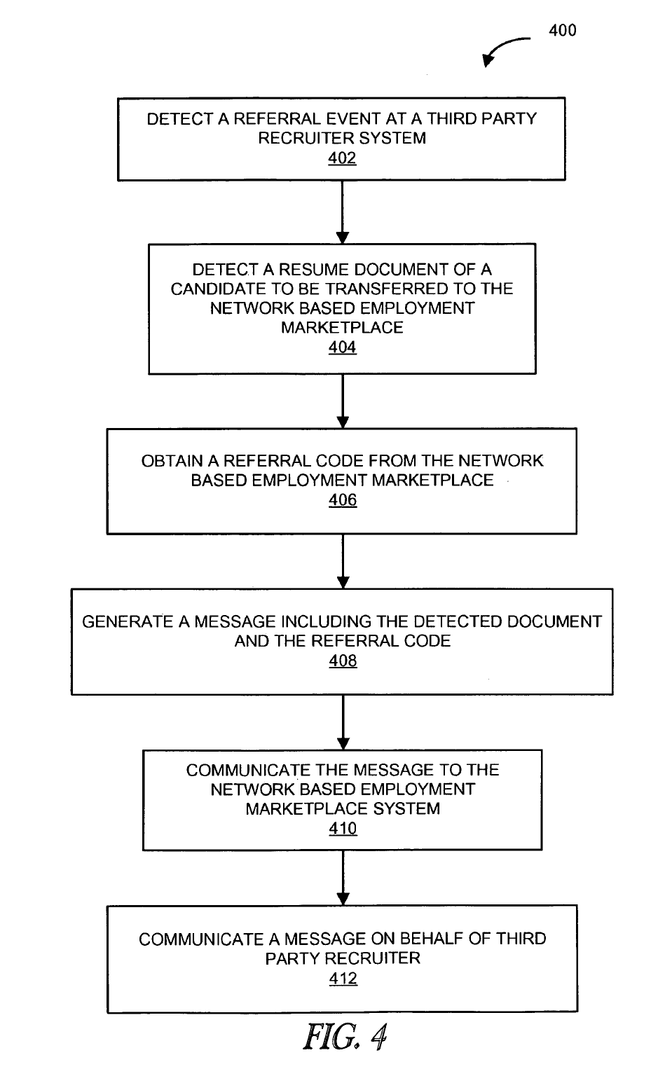

The candidate communications module 306 may be configured to generated an e-mail to the candidate, notifying the candidate that she has been or will be referred to the employment marketplace organization. The candidate is thus informed about the referral to the employment marketplace organization and also receives an invitation to become a member of the employment marketplace organization. In the invitation message that is sent from the employment marketplace organization, the one or more links to job listings provide an example of some of the services offered by the employment marketplace organization and may serve as an encouragement for the candidate to join the employment marketplace organization. Example operations that may be performed by the recruiter referral widget 300 may be described with reference to FIG. 4.

FIG. 4 is a flow chart of a method 400 to process a request for a dynamic web page, according to one example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at any of the client systems 110 and 120 of FIG. 1 and, specifically, at the referral widgets 112 and 122.

As shown in FIG. 4, the event detector 310 detects a referral event at operation 402. As mentioned above, a referral event may be associated with a resume document of a candidate being saved into a particular folder or being dragged onto a visual control associated with the recruiter referral widget 300. The resume document is detected at operation 404. At operation 406, the referral code module 304 obtains a referral code from the network-based employment marketplace system 140 (of FIG. 1). In one embodiment, the network-based employment marketplace system 140 may be associated with GetListed marketplace. As mentioned above, the referral code is generated to associate the referral of the candidate with the third party that originally obtained the resume document.

At operation 408, the upload module 306 generates a message that combines the resume document and the obtained referral code and communicates the message to the network-based employment marketplace system 140. The candidate communications module 308 generates and communicates a message (e.g., an e-mail message) to the candidate, on behalf of the third party recruiter, notifying the candidate of the referral to the network-based employment marketplace organization. It will be noted that the recruiter referral widget 300 may be configured to generate and send such message to the candidate either before uploading the resume document to the network-based employment marketplace system, or subsequent to it. Example architecture illustrating referral process may be described with reference to FIG. 5.

FIG. 5 illustrates an architecture 500 of the referral process in accordance with an example embodiment. As shown in FIG. 5, a referral processing system 530 may receive communications from a recruiter referral widget via a network 520. The referral processing system 530, in one example embodiment, may be provided as part of the network based employment marketplace system 140 of FIG. 1.

A recruiter referral 522, received at the referral processing system 530, is processed by various processing modules as will be discussed further below. The result of processing, in one example embodiment, is an invitation message 524. The invitation message 524 may be communicated to the candidate and include an invitation to join the associated network based employment marketplace organization. The invitation message 524 may also include, as mentioned above, instructions describing how to join the employment marketplace organization and one or more links to job listings identified as matching the candidate's proposed profile by the referral processing system 530. In some embodiments, the invitation message 524 may include the proposed profile. In further embodiments, the proposed profile is not communicated to the candidate as part of the invitation message 524 and may be made accessible to the candidate during the registration process after some additional verification of the candidate takes place (e.g., verification of the candidate's name, e-mail, address, etc).

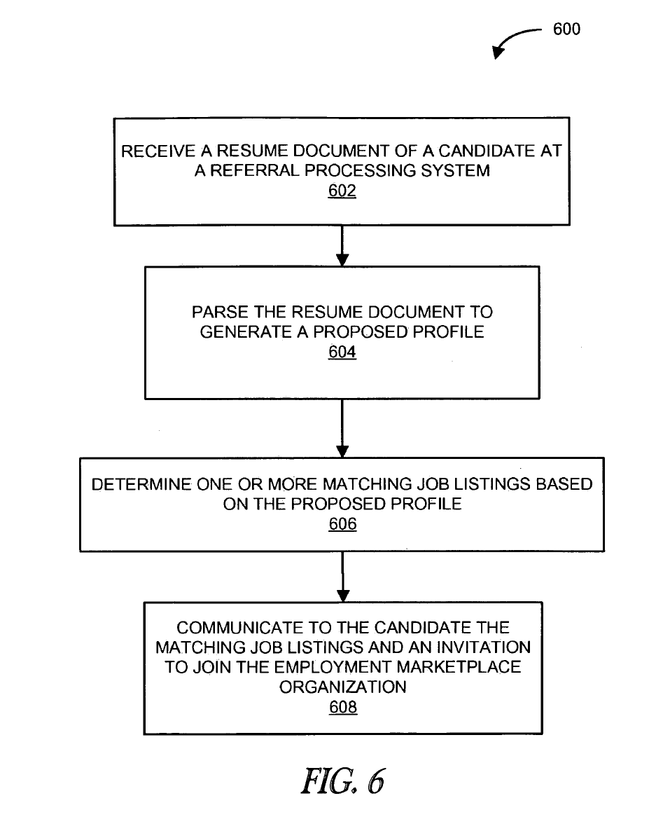

The referral processing system 530, as shown in FIG. 5, includes a data extractor 532, a profile generator 534, a query generator 536, a matching module 538, and an e-mail generator 550. These modules may be engaged to process a referral obtained from a third party recruiter. The referral processing system 530 may also include a registration module 560. The registration module 560 may be configured to perform operations to register a candidate with the network-based employment marketplace organization. Also illustrated in FIG. 5 is a storage 540 to store potential employees (candidates) records 542 and potential employers records 544. Example operations performed by various modules of the referral processing system 530 in response to receiving the referral 522 from a recruiter referral widget may be described with reference to FIG. 6.

FIG. 6 is a flow chart of a method 600 to process a referral, according to one example embodiment. The method 600 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the network based employment marketplace system 140 of FIG. 1 and, specifically, at the referral processing system 530. In another example embodiment, the processing logic may be distributed between various servers within the network based employment marketplace system 140 of FIG. 1.

As shown, in FIG. 6, a resume of a candidate is received at the referral processing system 530 at operation 602. The data extractor 532 parses the received resume document to extract the referral code and personal information of the candidate contained in the resume and the profile generator 534 generates a proposed profile for the candidate based on the extracted information. The proposed profile may include information such as candidate's name, contact information, past and current employment data, candidate's employment objectives and preferences, compensation requirements, etc. The matching module 538 may interrogate a database storing job listings (the potential employers records 542) utilizing one or more queries generated by the query generator 536, and determine one or more matching job listings at operation 606. The generated query and the matching operation is based on the data extracted from the received resume or based on the generated profile for the candidate.

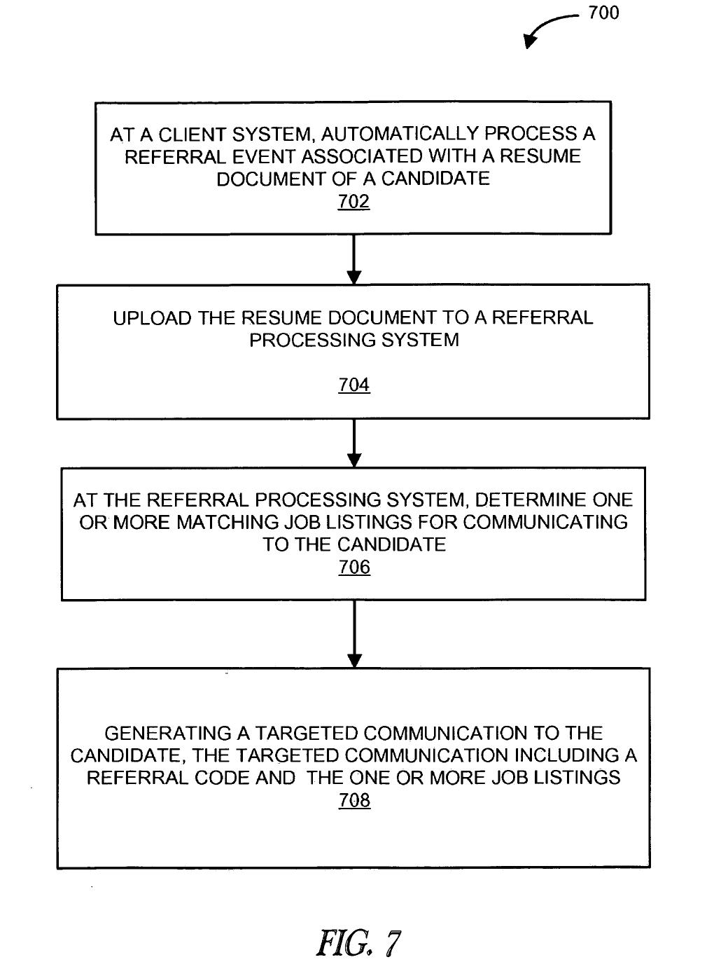

The matching module 538 may pass any identified matches to the e-mail generator 550. The e-mail generator 550 generates a communication for sending to the candidate. The communication (e.g., an e-mail) may include any determined matching job listings, an invitation to the candidate to join the employment marketplace organization (e.g., GetListed marketplace), and the referral code. The referral code that links the candidate's resume with the source of the referral (e.g., a third party recruiter) may be also used to authenticate the candidate when the candidate is attempting to access the job listings (e.g., via links provided in the e-mail from the referral processing system 530) and/or during the registration process, should the candidate choose to join the network-based employment marketplace organization. The communication generated by the e-mail generator 550 is sent to the candidate at operation 608. While FIG. 6 illustrates a method performed by various modules of the referral processing system 530 of FIG. 7, an example method illustrating using the recruiter referral widget 112 in conjunction with the referral processing system 530 can be described with reference to FIG. 7.

FIG. 7 is a flow chart of a method 700 to generate and process a referral utilizing a recruiter referral widget in conjunction with a network based employment marketplace system, according to one example embodiment. The method 700 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the transaction processing system 140 of FIG. 1 (specifically, at the contract-centric content system 142), as well as at the recruiter system 110 of FIG. 1.

As shown in FIG. 7, a referral event associated with a resume document of a candidate is detected and automatically processed at the recruiter referral widget 112 of FIG. 1, at operation 702. At operation 704, the resume document is uploaded to the referral processing system 142 of FIG. 1, together with a referral code that provides unique association between the referred resume and the referring third party. The referral processing system 142 processes the received resume and determines, at operation 706, one or more matching job listings from the employers records stored in the storage 144. At operation 708, the referral processing system 142 generates a targeted message including the referral code and any matching job listings and sends the targeted message to the candidate.

Thus, a system has been described that facilitates a one-step process for third party recruiters to process candidates' resumes for referring to the network based employment marketplace. In one example embodiment, the system may be implemented as a recruiter referral widget hosted at a third party recruiter's computer system that permits users to drag one or more resume documents document onto a visual control associated with the recruiter referral widget or to save the resume document into a folder that is being monitored by the recruiter referral widget. Both methods result in uploading of the resume document to the network based employment marketplace system for processing. At the network based employment marketplace system, the resume document may be is used to send a targeted acquisition e-mail to the candidate in order to present to the candidate a compelling reason to sign up with the network based employment marketplace.

The items that may be extracted from a referred resume document to be included in the targeted e-mail may include the following information.

i. Full Name

ii. Email address

iii. Experience history

iv. Education history

v. Objective

vi. Skills

Furthermore, in order to uniquely associate the referral associated with the candidate's resume document with the referring third party, an example recruiter referral widget may obtain a unique referral code from the network based employment marketplace system. A unique referral code may be included in any communication that is related to the referral, e.g., in communications between the candidate, the third party recruiter and the network based employment marketplace system.

Candidates who choose to sign up and become members of the network based employment marketplace system may have a profile generated for them and made available to prospective employers via a web site associated with the network based employment marketplace system. The profile of a member may be based on the proposed profile generated using the information obtained from the candidate's resume. A new member of the network based employment marketplace system may be requested to provide personal information, such as a full name, an e-mail address and a password in order to create an account with the network based employment marketplace system. The name and the e-mail address of a member may be used to verify that the proposed profile of a candidate matches the member's personal information. If a member accepts the proposed profile, their account is considered complete.

In one example embodiment, a machine-readable medium is provided having instruction data to cause a machine to detect a referral event at a third party system, to obtain a referral code that may uniquely associate the resume document with the third party, and to upload the resume document and the associated referral code to an employment marketplace organization. Example referral events may be associated with a resume document being stored to a particular target folder or being dragged onto a particular visual control presented as part of the GUI.

Machine readable medium will be understood as a medium that is capable of storing data in a form that can be accessed by an automated sensing device. Examples of machine-readable media include magnetic disks, cards, tapes, optical disks, as well as other forms of volatile and non-volatile memory devices.

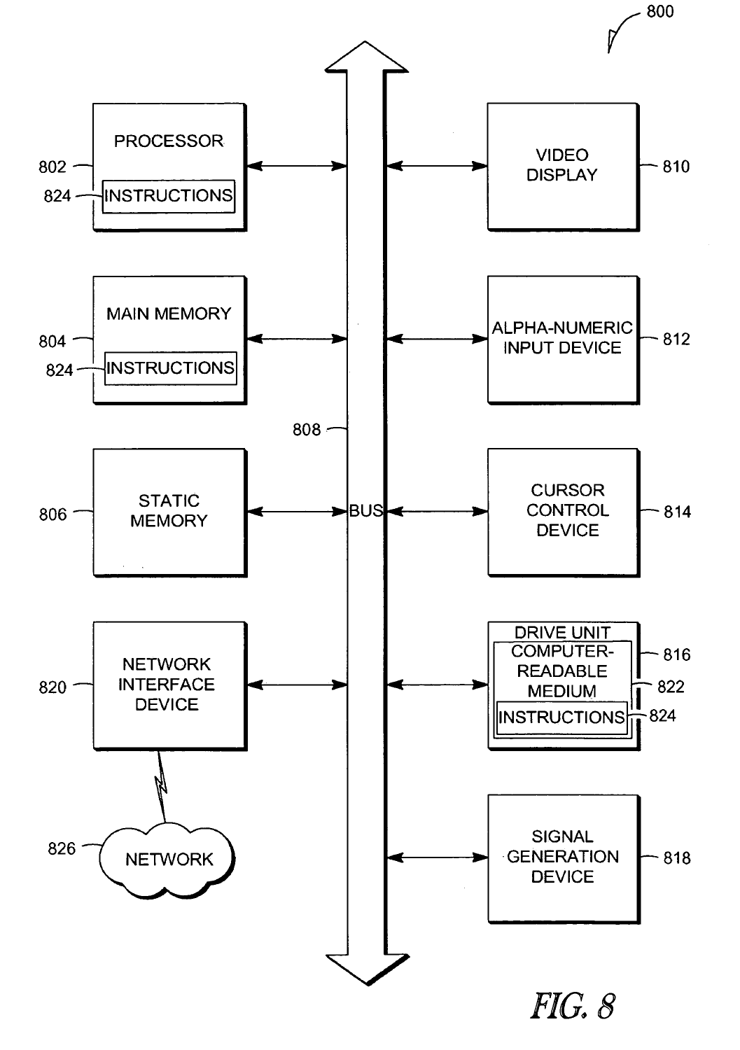

FIG. 8 shows a diagrammatic representation of a machine in the example form of a computer system 800 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alpha-numeric input device 812 (e.g., a keyboard), a user interface (UI) navigation device 814 (e.g., a cursor control device), a disk drive unit 816, a signal generation device 818 (e.g., a speaker) and a network interface device 820.

The disk drive unit 816 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

The software 824 may further be transmitted or received over a network 826 via the network interface device 820 utilizing any one of a number of well-known transfer protocols (e.g., Hyper Text Transfer Protocol (HTTP)).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of embodiments of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Thus, a recruiter referral widget has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A system comprising:
an event detector to detect a referral event at a third party system, the referral event being associated with a resume document;
a referral code module to obtain a token, the token to uniquely associate the resume document with the third party; and an upload module to upload the resume document and the associated token to an employment marketplace organization.

2. The system of claim 1, wherein the referral event is associated with a storage folder receiving the resume document.

3. The system of claim 1, wherein the referral event is associated with a graphical user interface (GUI) action of dragging the resume document to a target.

4. The system of claim 1, wherein the referral event is associated with activating the referral control at the third party system.

5. The system of claim 1, wherein the referral code module is to obtain the token from the employment marketplace organization.

6. The system of claim 1, wherein the third party system is associated with a recruiting agency.

7. The system of claim 1, wherein the third party system is associated with an alumni organization.

8. The system of claim 1, including a candidate communications module to send a communication to a candidate associated with the resume document in response to the uploading of the resume document to the employment marketplace organization.

9. A computer-implemented method, the method comprising:
detecting a referral event at a third party system, the referral event being associated with a resume document;
obtaining a token, the token to uniquely associate the resume document with the third party; and
uploading the resume document and the associated token to an employment marketplace organization.

10. The method of claim 9, wherein the referral event is associated with a storage folder receiving the resume document.

11. The method of claim 9, wherein the referral event is associated with a graphical user interface (GUI) action of dragging the resume document to a target.

12. The method of claim 9, wherein the referral event is associated with activating the referral control at the third party system.

13. The method of claim 9, wherein the obtaining of the token comprises:
requesting the token from the employment marketplace organization; and
receiving the token from the employment marketplace organization.

14. The method of claim 9, wherein the third party system is associated with a recruiting agency.

15. The method of claim 9, wherein the third party system is associated with an alumni organization.

16. The method of claim 9, further comprising sending a communication to a candidate associated with the resume document.

17. A method comprising:
receiving, at an employment marketplace organization, a resume document of a candidate and an associated token;
generating a proposed candidate profile based on the resume document;
matching the proposed candidate profile with job listings available to the employment marketplace organization;
generating one or more matching listings based on the results of the matching; and
communicating the one or more matching listings and the token to the candidate.

18. The method of claim 17, further comprising storing the proposed profile at the employment marketplace organization.

19. The method of claim 17, wherein the communicating of the one or more matching listings and the token to the candidate includes an invitation to become a member of the employment marketplace organization.

20. The method of claim 17, wherein the communicating of the one or more matching listings includes providing a web link for each of the matching listings.
